(19) United States
(12) Patent Application Publication
(10) Pub. No.: US 2015/0041500 A1
(43) Pub. Date: Feb. 12, 2015

(54) DISPENSER AND MEASURING CAP DEVICE AND METHOD

(71) Applicant: Muhammad Sami Ismail, Nashville, TN (US)

(72) Inventor: Muhammad Sami Ismail, Nashville, TN (US)

(21) Appl. No.: 13/964,709

(22) Filed: Aug. 12, 2013

(51) Int. Cl. G01F 11/28

(52) U.S. Cl. CPC G01F 11/282
USPC 222/434; 222/450; 222/452

(57) ABSTRACT

A spill and contaminant resistant dispenser and measuring cap device and method for measuring and dispensing a desired amount of a bulk particulate, powdery, granular or viscous liquid substance from a storage container through a cap. A dispenser and measuring cap is attached to a storage container. The cap has one or more measuring chamber ducts, each having a different predetermined volume. The measuring chamber ducts are selectively and separately operationally aligned with an internal funnel stem and a dispensing spout. A selected measuring chamber duct is filled with the substance by inverting the cap and attached container. A measured amount of the substance is captured and dispensed, and the unused portion of the substance retained in the storage container without exposure to outside contaminants or implements, by rotating the duct into operational alignment with the spout.

### FIELD OF USE

The present invention relates generally to the field of closures for storage containers. More specifically, the present invention relates to a spill- and contamination-resistant dispenser and measuring cap for accurately measuring and dispensing a specific amount of a bulk substance from a storage container such as a bottle, jar, canister, jug, can and/or carton.

### BACKGROUND OF THE INVENTION

Many common food products, medicines, medicaments and other consumable substances are frequently stored in bulk quantities using relatively small, easily portable storage containers such as bottles, jars and canisters by individuals, retailers, and health care facilities for later dispensation, administration and/or use. Substances commonly stored in bulk are usually particulate, powdery, and/or granular substances such as medicines, medicaments, thickeners, baby formula, protein powders, coffee, sweeteners and other dry goods, but may also comprise viscous liquid substances such as cough syrups, honey, baby foods or fluid gels.

The accurate measuring and dispensation of a specific amount of a substance stored in bulk typically necessitates the use of at least four separate items, including (1) a storage container containing a substance to be measured and dispensed, (2) a closure for sealing the storage container and protecting the contents thereof from contamination and accidental spillage, (3) a measuring device (e.g., a measuring spoon or beaker) for measuring out a specific amount of the substance, and (4) a receiving container (e.g., a cup or bottle) for administering the measured amount of the substance dispensed. The need for so many separate items can make the measuring and dispensing of specific amounts of bulk substances both difficult and time consuming because it requires a user to hold and/or manipulate multiple articles, either sequentially (by placing each item on a working surface when not in use, which is slower) or simultaneously (which while faster, is awkward and increases the risk of spilling the substance).

A fifth article for facilitating the transfer of the bulk substance from the storage container to the receiving container (e.g., a funnel) is also commonly used in applications where the opening (i.e., “mouth”) of the receiving container is particularly narrow or small compared to the measuring device or the opening of the storage container. However, the use of additional articles or tools to facilitate dispensation and administration increases the number of steps, risk of error and time required to achieve successful dispensation and administration of a measured amount of a substance, which can be problematic in situations where ease, consistency and speed of delivery are important.

These problems and risks can be further exacerbated by the use of traditional, reusable, open-top measuring devices, including measuring spoons, cups and beakers, because such devices are inaccurate, unreliable and susceptible to user error, which makes them inconsistent and prone to spilling. Such measuring devices also render the measured portion of the substance being dispensed, as well as the bulk portion remaining in the storage container, vulnerable to contamination by moisture, foreign substances, spoilage organisms and pathogens, which is especially problematic in the healthcare industry where accuracy and consistency of measurement, purity of substance, and avoidance of nosocomial infection is vital. In sum, traditional devices and methods for dispensing measured amounts of bulk substances are cumbersome, imprecise, inconsistent and subject the substance being dispensed to the needless risk of contamination and spoilage.

Various solutions to these problems have been proposed and found unsatisfactory. For example, omitting the use of a measuring device by simply pouring a bulk substance directly from a storage container into a receiving container (with or without the aid of a facilitating device such as a funnel) does not solve the foregoing deficiencies because this method prevents measurement and control of the amount being dispensed, and still exposes the substance to air, moisture, and other contaminants.

Additionally, some newer types of storage container closures having dual functions are known. For example, the caps provided with containers of some ingestible consumer products (e.g., cough syrup, mouth wash) serve both to seal the container when attached and as a dosing device when removed. These dosing caps allow the user to measure out and administer a predetermined volume of product into the cap when the cap is removed from the bottle. However, dosing caps are common fomites and must be cleaned prior to replacement of the cap on the storage container in order to prevent the transmission of germs spread to the cap by the user. Otherwise, any residual product inside the cap can migrate downward onto the exterior of the container, resulting in unwanted mess. Examples of dosing caps may be found in U.S. Pat. No. 4,892,126 to Bucherer et al., U.S. Pat. No. 5,662,249 to Grosse, and U.S. Pat. No. 5,865,331 to Jacobs et al.

Another newer type of closure facilitates the measurement and dispensation of a substance from a storage container without removing the cap. Some examples of these types of dispenser caps may be found in U.S. Pat. No. 2,748,995 to Hightower et al., U.S. Pat. No. 2,834,519 to Miller et al., U.S. Pat. No. 2,985,343 to Mask, U.S. Pat. No. 4,957,219 to Robbins et al., U.S. Pat. No. 5,855,302 to Fisscher et al., U.S. Pat. No. 6,422,426 to Robins, I I I et al., and U.S. Pat. Pub. No. 2001/0030165 A1 to Jacobs et al. One problem common to these types of dispenser caps is that they generally permit the manifestation of a direct, unobstructed channel or path between the interior of the storage container to which the cap is attached and the external environment at some point during their operation. This makes such caps prone to accidental spillage and contamination of the contents of the storage container by various external sources.

Although storage container and closure designers and manufacturers have developed many different variations of dosing caps and dispenser caps, there remains a need and a demand for a convenient, inexpensive, and easy to use spill- and contamination-resistant dispenser and measuring cap closure that can seal and protect the contents of a container from contamination by moisture, foreign substances and microorganisms during storage and use, and accurately, precisely and consistently measure and dispense a specific amount of a bulk substance from a container to which it is attached in one or more predetermined volumes corresponding to commonly prescribed amounts for a given substance.

The dispenser and measuring cap device disclosed herein satisfies this need through the provision of a single unitary closure for controlled measuring and dispensing of a substance from a storage container. The features and details of the device are listed and discussed below.

### SUMMARY OF THE INVENTION

The present invention provides a convenient, easy to use, and inexpensive spill- and contamination-resistant dispenser and measuring cap device and method for measuring and dispensing a specific amount of a bulk particulate, powdery, granular or viscous liquid substance from a storage container through a cap. The dispenser and measuring cap is attached to a storage container. The cap has one or more measuring chamber ducts, each having a different predetermined volume. The measuring chamber ducts are selectively and separately operationally aligned with an internal funnel stem and a dispensing spout. A selected measuring chamber duct is filled with the substance by inverting the cap and attached container. A measured amount of the substance is captured and dispensed, and the unused portion of the substance retained in the storage container without exposure to outside contaminants or implements, by rotating the duct into operational alignment with the spout. While there are many containers that may benefit from this invention, the invention is particularly useful with relatively small, hand-held and easily movable storage containers commonly found in modern homes, including bottles, jars, canisters, jugs, cans and/or cartons.

The dispenser and measuring cap device and methods of the present invention eliminate and/or significantly reduce the spillage and attendant waste inherent to dispensing a substance through the dosage and dispensing caps of the prior art. The device and methods of the present invention also provide for simple, accurate and consistent measurement and dispensing of a prescribed amount of a particular substance using one or more measuring chamber ducts having different predetermined volumes without exposing the substance being dispensed or remaining in the storage container to unnecessary environmental, microbiological and foreign-object contamination.

In one aspect, the dispenser and measuring cap of the present invention provides a device, which when sealably engaged with or attached to a storage container containing a particulate or viscous liquid substance, properly aligned and inverted, captures in an internal measuring chamber duct a precise amount of the substance from the storage container for dispensation through said cap. More specifically, once the internal measuring chamber duct inside the cap is operationally aligned with an interior funnel and inverted, gravity causes the substance to pass through the funnel and fill the duct. The measuring chamber duct is then closed and/or sealed off from the rest of the substance remaining in the storage container and a specific amount is measured out by activating a divider built into the cap to rotate the duct away from the funnel. The measured amount of the substance is then dispensed by rotating the internal measuring chamber duct into operational alignment with a separate closeable spout that extends axially from the top surface of the cap and on an opposite side from the funnel stem (i.e., the funnel stem and coverable spout are not vertically aligned and are unable to be placed in communication in the cap without the aid of the measuring chamber duct).

The present dispenser and measuring cap dispenses only the measured amount of the substance captured by the internal measuring chamber duct and retains and protects the remainder of the substance in the storage container from contamination by preventing the formation of a direct channel or path between the interior of the storage container and the external environment during all points of operation. These features of the invention allow a user to conveniently and easily (even single handedly) measure out and dispense a precise amount of a substance from a bulk storage container without exposing the unused portion of the substance to contamination, using only a single unitary item. The multifunctional design of the dispenser and measuring cap of the present invention also eliminates the need for a separate awkward measuring device that must be cleaned after each use.

In another aspect, the invention provides a method for one-handedly measuring and dispensing from a storage container a consistently accurate, specific amount of a bulk substance by sealably attaching a dispenser and measuring cap of the present invention to the opening or mouth of a storage container containing a particulate, powdery and/or granular, viscous liquid or fluid gel substance, arranging an internal measuring chamber duct into operational alignment an internal funnel, inverting the storage container to load a the measuring chamber duct with the substance, rotating the duct around a central axis to measure out a specific desired amount of the substance and put the duct into operational alignment with an external spout extending axially upward from the top surface of the cap, and dispensing the measured amount of the substance captured by the measuring chamber duct through the spout into a receiving container.

In one embodiment, the dispenser and measuring cap is a device that can be threaded onto or otherwise releasably yet sealably attached to a storage container for safe and reliable storage, measuring and dispensing of a specific amount of a particular substance from the storage container. In some embodiments, the substance may be a particulate, powdery and/or granular substance. In other embodiments, the substance may be a viscous liquid or fluid gel substance. In some related embodiments, the substance to be measured and dispensed is stored in the container in bulk quantities for periodic dispensation and/or use.

In one embodiment, the dispenser and measuring cap device comprises a measuring chamber duct having a predetermined volume. In another embodiment, the dispenser and measuring cap device comprises a plurality of measuring chamber ducts, each having a different predetermined volume. In yet another embodiment, the dispenser and measuring cap device comprises at least one measuring chamber having a variable volume that is adjustable by a user. In some embodiments, the predetermined volume of a given measuring chamber duct corresponds to the generally recommended and/or prescribed dosing amount for common particulate, powdery, and/or granular, viscous liquid or fluid gel food products, dietary supplements, medicines and other consumable substances, including without limitation, baby formula, viscous baby foods, protein powders, coffee, sweeteners, cough syrups, honey, baby foods, fluid gels such as analgesic gels, and food additives and thickeners for treating dysphagia and similar conditions.

In some additional embodiments, the divider for measuring and transferring an amount of a substance from a storage container to the spout for dispensation may be activated by turning, twisting or rotating the divider around a central axis extending axially through the dispenser and measuring cap of the invention. In other embodiments, the divider may comprise an arm or tab-shaped member that extends and/or protrudes from an external surface of the cap.

These and other advantages of the present invention, together with various embodiments thereof, will be more fully understood by those skilled in the art with reference to the following detailed description, claims and accompanying drawings.

### BRIEF DESCRIPTION OF THE DRAWINGS

FIG. 1 shows a perspective top view of a dispenser and measuring cap of the present invention;

FIG. 2 shows a perspective top view of a dispenser and measuring cap of the present invention attached to a cylindrical storage container;

FIG. 3 shows a perspective bottom view of a dispenser and measuring cap of the present invention;

FIG. 4 shows a side view of a dispenser and measuring cap of the present invention attached to a cylindrical storage container;

FIG. 5 shows a top view of a dispenser and measuring cap of the present invention;

FIG. 6 shows an exploded bottom view of a dispenser and measuring cap of the present invention and a storage container;

FIG. 7 shows an exploded top view of a dispenser and measuring cap of the present invention and a storage container;

FIG. 8 shows a cutaway partially exploded bottom view of a dispenser and measuring cap of the present invention with a storage container; and

FIG. 9 shows a perspective top view of one embodiment of the divider portion of the dispenser and measuring cap of the present invention having multiple measuring chamber ducts.

### DETAILED DESCRIPTION OF THE INVENTION

In accordance with the present invention, an inexpensive and easy to use unitary dispenser and measuring cap closure designed to sealably engage a storage container and accurately and consistently measure and dispense a desired amount of substance therefrom is provided. In one embodiment, the amount dispensed is a single dose or single serving of substance. The presently disclosed dispenser and measuring cap device is a type of closure that attaches to the opening or mouth of various types of relatively small containers commonly used in homes, retail establishments and healthcare facilities to store food products, dietary supplements, medicines and other consumable particulate, powdery, and/or granular, viscous liquid or fluid gel substances in bulk quantities for periodic dispensation and administration.

The dispenser and measuring cap device solves the problems of prior art dosing and dispensing caps by providing an inexpensive device that is more convenient and easier to use, the device being operable to accurately measure and dispense a substance with only one hand once it is attached to an appropriate storage container. The present dispenser and measuring cap also provides for more accurate and consistent, reliable measurement and dispensing of a desired amount of particulate, powdery, granular or viscous liquid substances through the use of one or more completely enclosed internal measuring chamber ducts having predetermined volumes to capture and segregate a desired amount of the substance to be dispensed from the unused portion of the substance remaining in the container.

The cap of the present invention further improves over the art by simultaneously sealing and protecting the contents of the container from inadvertent spillage and contamination by moisture, foreign substances and microorganisms during use and/or storage through nonlinear vertical positioning and separation of the two primary apertures for independently loading the internal measuring chamber duct with a measured amount of a substance and dispensing the substance from the duct through the cap to a receiving container.

More specifically, the internal aperture through which a measuring chamber duct is filled with a substance from the storage container (i.e., a funnel stem) and the external spout through which the substance is dispensed are not vertically or operationally aligned. Rather, the two are disposed on opposite sides of a central axis extending vertically through the cap and separated by an intervening divider so that they cannot be placed in communication and/or operational alignment with each other without the aid of an internal measuring chamber duct contained within the intervening divider. Additionally, the funnel stem is not and cannot be vertically or operationally aligned with the external spout through which the substance is dispensed to create a direct passage or channel between the interior of the storage container and the external environment. The intervening divider containing an internal measuring chamber duct thus functions as a barrier or obstruction to prevent spilling and contamination of the contents of the container, as well as a measuring device and a shuttlecock for measuring out and transferring a measured amount of a substance from the storage container through the funnel stem to the spout. The internal measuring chamber duct is integral to the intervening divider and is moved between a first filling or loading position in operational alignment with the funnel stem and a second dispensing position in operational alignment with the external spout by grasping an external rim of the divider and turning, twisting or rotating the divider around the central axis of the device. In this way, the cap of the present invention is both spill resistant and contamination resistant.

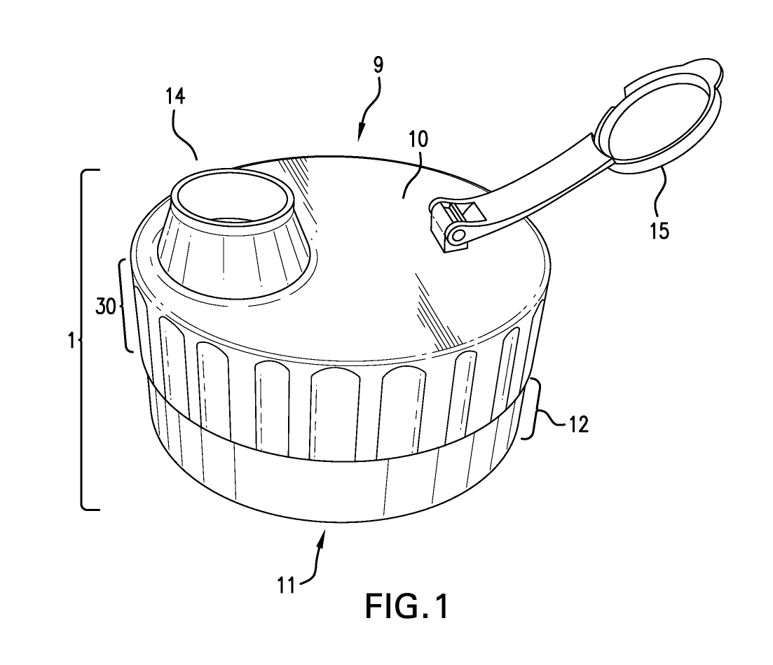

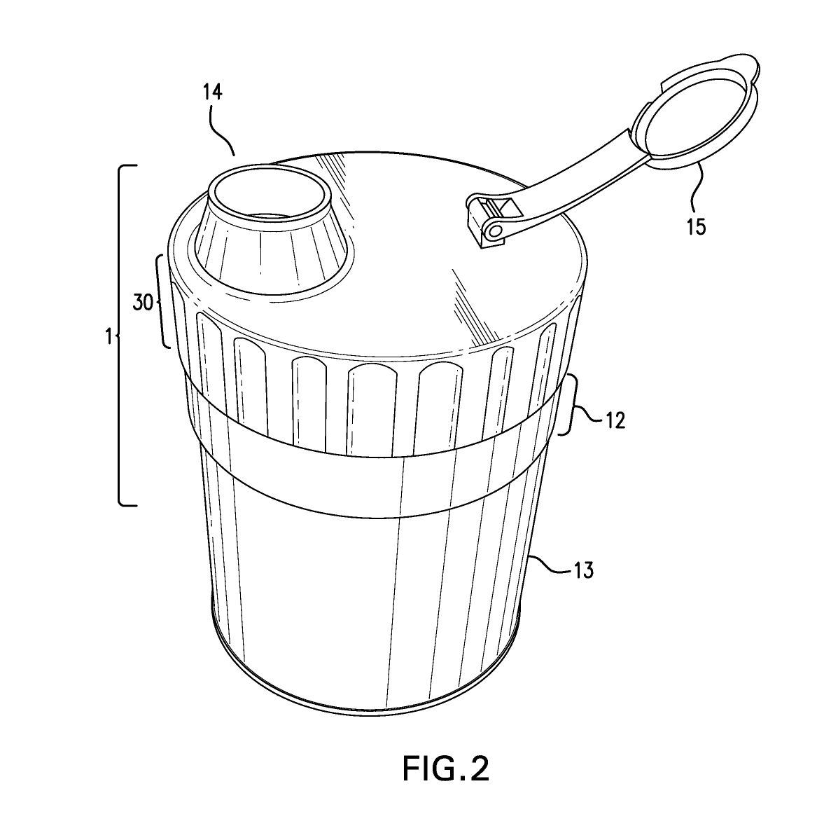

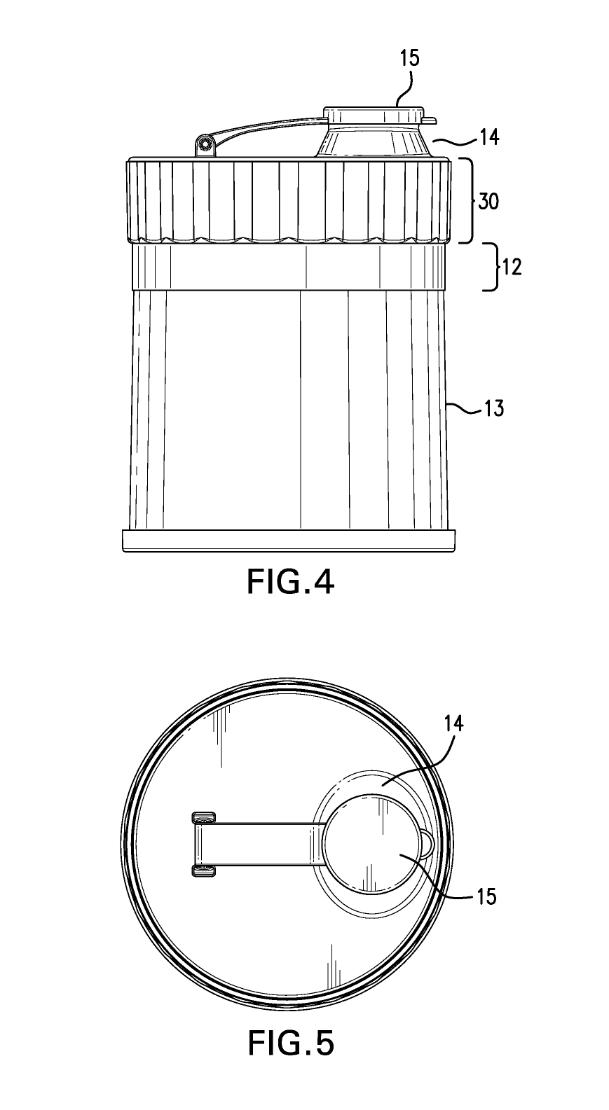

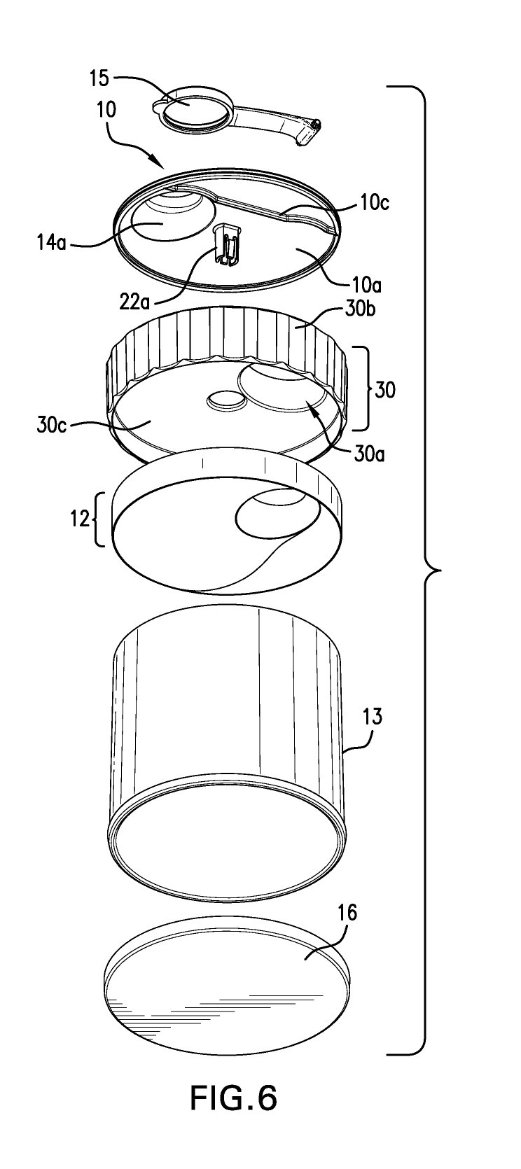

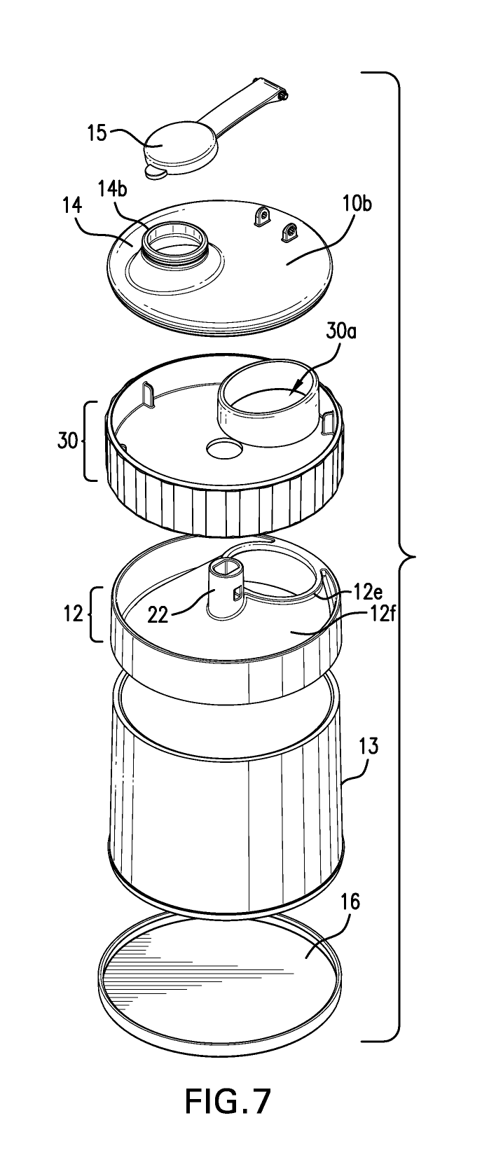

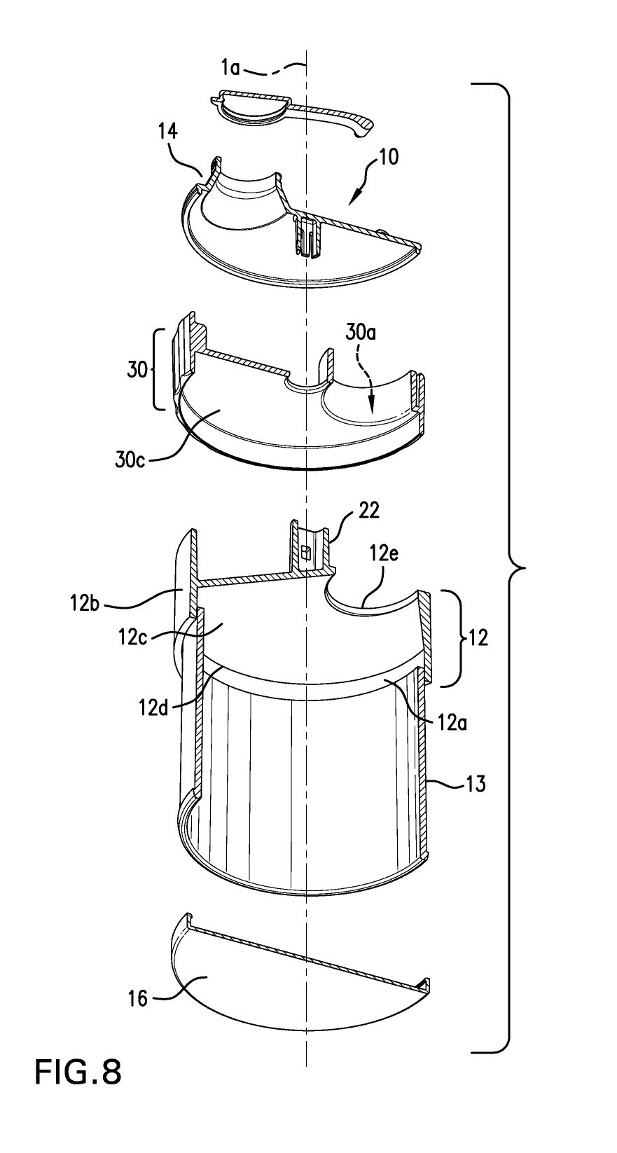

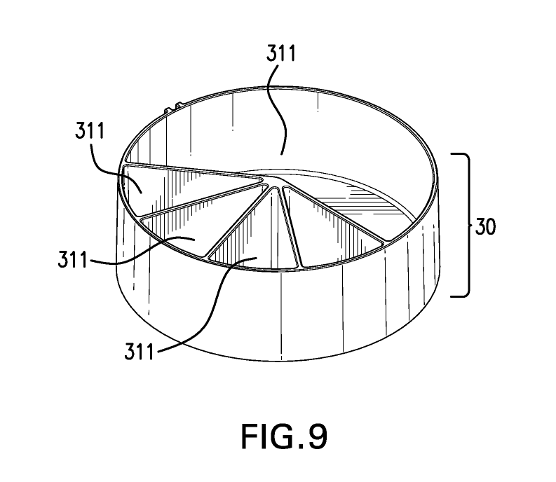

As shown in FIGS. 1, 2, 4 and 5, the dispenser and measuring cap device 1 of the present invention is a closure for a storage container and comprises a proximal end 9, a distal end 11, a divider 30 disposed between the proximal and distal ends, and an axle 22 extending through and connecting the proximal end, distal end, and divider along a center axis 1a (see FIG. 8). The proximal end 9 comprises a proximal end piece 10 comprising a closeable dispensing spout 14, a dispensing spout lid 15, an internal surface 10a and an external surface 10b (see FIGS. 6-7). The closeable dispensing spout 14 is positioned off-center from the center axis 1a of the device 1 and comprises an inlet 14a disposed on and flush with the internal surface 10a of the proximal end piece 10, and an outlet 14b extending upward from the external surface 10b of the proximal end piece 10 (see FIGS. 6-7). The outlet 14b of the spout 14 may be any size and/or shape, but in one embodiment, the outlet 14b has a smaller diameter and/or circumference than the inlet 14a. The dispensing spout lid 15 is attached to the external surface 10b of the proximal end piece 10 of the device 1 and is adapted to releasably close, cover and/or seal the dispensing outlet 14b of the dispensing spout 14 (see FIGS. 4-5).

The distal end 11 of the dispenser and measuring cap device 1 comprises an interface 12 adapted to releasably yet sealably engage the opening or mouth of an appropriate storage container 13. The interface 12 may be adapted to engage the storage container 13 with any means sufficient to form a seal capable of preventing the escape from or introduction into the storage container 13, through the interface 12, of any substance or contaminant during use or storage of the container while the device 1 is installed. Suitable means for sealably engaging (i.e., attaching) the interface 12 of the device 1 with the opening or mouth of a storage container 13 include, for example, screw threads, latches, insets, snaps, clips, tape, adhesive, nesting diameter, interlocking complementary geometry and the like. In one embodiment (not shown), the storage container 13 and the dispenser and measuring cap device 1 are molded as a single piece. In an alternate embodiment (not shown), the storage container 13 is molded as a single piece with the interface 12 portion of the device 1. In another alternate embodiment, the dispenser and measuring cap device 1 further comprises an integral storage container having a separate opening or lid 16 for placing a substance in the storage container (see FIGS. 6-8). The “separate opening” 16 of the integral storage container is interchangeable with “opening” and/or “lid”.

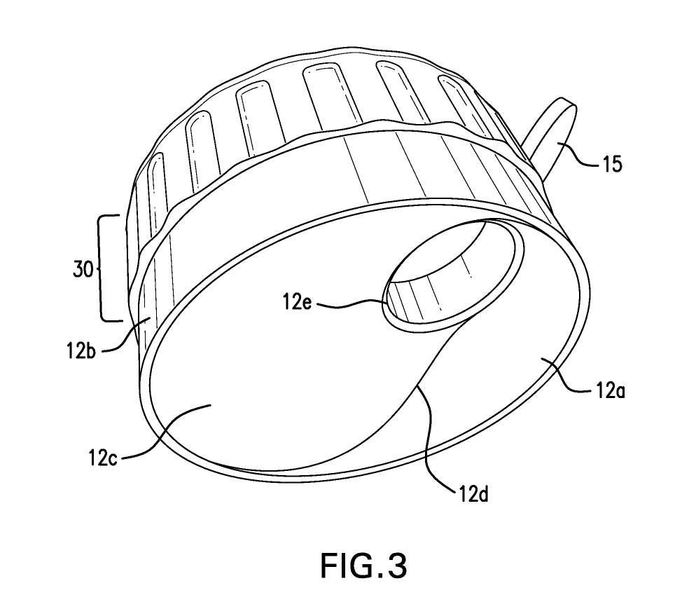

As shown in FIGS. 3, 7 and 8, the interface 12 further comprises a lower side 12a, and an outside 12b adapted to be gripped and manipulated by a user. The lower side 12a of the interface 12 comprises a shallow interface funnel 12c facing the inside of the storage container 13. The shallow funnel 12c has a wide mouth 12d that slopes away from the inside of the storage container and defines a short funnel stem 12e through which the substance to be dispensed must pass. The funnel stem 12e is positioned off-center from the center axis 1a of the device 1 and extends upward from the wide mouth 12d toward the proximal end 9 of the device 1 to the divider 30. In some embodiments, the funnel stem 12e and closeable dispensing spout 14 are disposed on opposite sides of a central axis from each other. In one embodiment, the short funnel stem 12e is omitted and the interface funnel 12c resolves as a simple aperture or hole having no significant depth (not shown). In some embodiments, the wide mouth 12d is substantially the same size and diameter as the opening or mouth of the storage container 13. In other embodiments, the wide mouth 12d may have a larger or smaller size and diameter than the opening or mouth of the storage container 13. The interface 12 also comprises a upper side 12f opposite the interface funnel 12c. In some embodiments, the upper side 12f is sloped to reflect the inverted slope of the interface funnel 12c as shown in FIG. 7. In other embodiments, the upper side 12f is flat (not shown) and substantially contacts the lower internal surface 30c of the divider 30 (i.e., the upper side 12f does not reflect the inverted slope of the interface funnel 12c shown in FIG. 3).

As shown in FIGS. 6, 7 and 8, a divider 30 having an external rim 30b is disposed between the spout 14 of the proximal end 9 and the interface 12 of the distal end 11. In one embodiment, the divider 30 is shaped like a disc and is circumscribed by the external rim 30b. The divider 30 is also penetrated axially by at least one measuring chamber duct 30a having a discernable length and/or depth defining a predetermined internal volume equal to a single dose or single serving of a substance to be measured and dispensed. For example, in one embodiment, the internal volume defined by the measuring chamber duct 30a equals a single dose or single serving for a particular brand of baby formula being measured and dispensed by the dispenser and measuring cap device 1 of the present invention.

In another embodiment, the measuring chamber duct 30a is a cylindrical pipe passing through the divider 30. In yet another embodiment, the measuring chamber duct 30a has an elliptical, square, rectangular or triangular shape. In still yet another embodiment, the measuring chamber duct 30a is defined by a void cut out from an otherwise solid divider 30. In even yet another embodiment, the measuring chamber duct 30a is the same shape and size as the funnel stem 12e defined by the terminal end of the interface funnel 12c. In other embodiments, the divider 30 may comprise a plurality of measuring chamber ducts 311 (see FIG. 9) and/or more than one spout 14 (not shown). In a related embodiment, each measuring chamber duct of the plurality 311 has a different size and volume.

In other embodiments, the external rim 30b of the divider 30 may be marked with indicia or labels to assist a user in determining the specific volume(s) of one or more measuring chamber ducts 30a, 311. In related embodiments, the external rim 30b of the divider 30 may be turned or “dialed” by a user to select a desired amount of substance to be measured and dispensed according to, in some embodiments, indicia or labels which may be present on the exterior surface 12b of the interface 12, the proximal end piece 10 of the device 1, and/or on the external rim 30b of the divider 30. In some embodiments the outside rim 30b of the divider 30 may be marked or labeled to indicate whether a measuring chamber duct 30a is in operational alignment with the funnel stem 12e or spout 14. In additional embodiments, the indicia are legible from both an inverted or upright position.

As also shown in FIGS. 6, 7 and 8, the proximal end piece 10 of the dispenser and measuring cap device 1 is attached to the interface 12 by an axle 22. In one embodiment, the axle 22 passes through the divider 30 along the center axis 1a in such a way so as to enable the divider 30 to spin, turn, twist or rotate on the axle 22 relative to the proximal end piece 10 and the interface 12. Other means of attachment may be appropriate so long as the divider 30 and its integral measuring chamber duct 30a may rotate about the center axis 1a. In another embodiment, the overall diameter of the divider 30 is greater than the overall diameters of both the proximal end piece 10 and the interface 12, so that the divider 30 transects the dispenser and measuring cap device 1. In yet another embodiment, the external rim 30b of the divider 30 extends radially beyond and overlaps the respective adjacent edges of the proximal end piece 10 and the interface 12, thereby providing a comfortable area for a user to grip and easily rotate the divider 30 and the integral measuring chamber duct 30a therein. In this way, the divider 30 serves as an intervening barrier between the funnel stem 12e and the dispensing spout 14 and protects the contents of an attached storage container 13 from spillage and contamination by preventing uncontrolled communication between the two.

In some embodiments, the axle 22 comprises a locking mechanism 22a that extends downward internally from the internal surface 10a of the proximal end piece 10 through the divider 30 to connect the proximal end piece 10 to the interface 12. In other embodiments, the locking mechanism 22a also inhibits the divider 30 from rotating beyond a particular position or completely inhibits all rotation of the divider 30. In an alternate embodiment, the internal surface 10a of the proximal end piece 10 comprises a stop member 10c against which the measuring chamber duct 30a of the divider 30 may abut to inhibit the rotation of the measuring chamber duct 30a to less than 360 degrees, including, in one embodiment, to approximately 180 degrees, and thereby facilitate precise alignment of the measuring chamber duct 30a with the dispensing spout 14 and the funnel stem 12e. In another embodiment, the stop member 10c facilitates precise operational alignment of the measuring chamber duct 30a with the dispensing spout 14 and the funnel stem 12e by limiting the rotation of the duct to an angle defined by the spout 14 at a first position and the stem 12e at a second position.

As shown in FIG. 8, the spout 14 and the funnel stem 12e are disposed within the device 1 on opposite sides of a central axis 1a at an angle of about 180 degrees to each other. The spout 14 and the funnel stem 12e cannot be vertically or operationally aligned to create a direct passage or channel between the interior of the storage container 13 through the funnel stem 12e and the external environment through the dispensing spout 14. Additionally, the measuring chamber duct cannot be operationally aligned (i.e., communicatively aligned in whole or part so as to allow the transfer of a substance from or through the aligned members) with both the funnel stem 12e and the spout 14 at the same time. This arrangement makes the formation of a clear passage between the interior of the storage container 13 and the external environment impossible, thus all but eliminating the risk of accidental spillage and the contamination of the contents of the container 13 by precluding the uncontrolled passage of materials (including the substance to be dispensed and contaminants) through device 1. Indeed, measurement and dispensation of a substance from the storage container can only be achieved by moving the measuring chamber duct 30a in and out of operational alignment with first the funnel stem 12e of the interface funnel 12c and then the dispensing spout 14 by turning, twisting or rotating the external rim 30b of the divider 30.

The measuring chamber duct 30a must be operatively aligned with the funnel stem 12e to funnel the substance from the opening of the storage container 13 through the interface funnel 12c into the measuring chamber duct 30a. If the measuring chamber duct 30a is not operatively aligned (i.e., not at least partially vertically aligned) with the stem 12e of the interface funnel 12c, the funnel stem 12e will remain closed and/or sealed off at its proximal end by the flat lower internal surface 30c of the divider 30. Coordinately, in embodiments where the upper side 12f of the interface 12 is flat, the measuring chamber duct 30a will remain closed and/or sealed off from the storage container 13 at its distal end by the flat upper side 12f of the interface 12 while it is not operatively aligned with the funnel stem 12e.

A quantity of substance is loaded into the measuring chamber duct 30a from the storage container 13 by inverting the device 1 and storage container 13. Gravity forces the substance through the interface funnel 12c and funnel stem 12e into the measuring chamber duct 30a to the point of overflowing. Measurement and dispensation of a precise predetermined amount of the substance is then be achieved by manipulating the external rim 30b of the divider 30 to rotate the measuring chamber duct 30a out of operational alignment with the funnel stem 12e at a first position and into operational alignment with the spout 14 at a second position. The movement of the measuring chamber duct 30a out of alignment with the funnel stem 12e causes the excess substance overflowing the measuring chamber duct 30a to be scraped off by an internal edge of the funnel stem 12e as the measuring chamber duct 30a rotates out of operational alignment. Excess substance falls back into the storage container 13 while the amount of substance to be dispensed is captured by the measuring chamber duct 30a and prohibited from backflowing into the storage container 13.

When the measuring chamber duct 30a is not operationally aligned with the spout 14, the measuring chamber duct 30a is closed and/or sealed off at its proximal end by the flat internal surface 10a of the proximal end piece 10 of the device 1. Thus, dispensation of the measured amount of substance requires rotation of the measuring chamber duct 30a into operational alignment with the spout 14. Once the measuring chamber duct 30a and the spout are operational aligned, the measured amount of substance will fall out of the measuring chamber duct 30a into the inlet 14a of the closeable dispensing spout 14. In one embodiment, the inlet 14a of the spout 14 has the same size and shape as the measuring chamber duct 30a. The spout lid 15 must be removed from the dispensing spout 14 to dispense the measured amount of substance into a receiving container (i.e., the spout must be open and not closed). However, if the spout lid 15 is opened or the outlet 14b of the spout 14 is otherwise not closed or sealed when the measuring chamber duct 30a is full of substance and operationally aligned with the spout inlet 14a, inverting the storage container 13 and device 1 will transfer the substance out of the measuring chamber duct 30a, through the spout 14 and into a receiving container (not shown) in the same step.

The dispenser and measuring cap device 1 of the present invention therefore prevents any substance from exiting the storage container 13 unless it is (1) poured from the storage container 13 into the interface funnel 12c, (2) transferred from the interface funnel 12c through the funnel stem 12e into the measuring chamber duct 30a, (3) rotated with the measuring chamber duct 30a into operational alignment with the spout inlet 14a, and (5) poured through the spout outlet 14b out of an open spout 14. Conversely, the only way for contaminants and foreign matter to reach the bulk substance in the storage container 13 is by passing through the same steps in reverse order. While a user may easily accomplish each of these steps by purposely inverting the presently disclosed device 1 and twisting the divider rim 30b, it is highly improbable that these steps could be accomplished inadvertently.

All references, including publications, patent applications, and patents, cited herein are hereby incorporated by reference to the same extent as if each reference were individually and specifically indicated to be incorporated by reference and were set forth in its entirety herein.

Any capitalized and/or defined terms appearing in the specification include all variants, and singular and/or plural versions of the terms used herein and are not intended to be limiting or comprehensive, but merely to provide reference tools for understanding the invention. The use of the terms “a” and “an” and “the” and similar referents in the context of describing an invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., “including, but not limited to,”) unless otherwise noted. Recitation of ranges as values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) herein, is intended merely to better illuminate the invention and does not pose a limitation on the scope of the invention (i.e., “such as, but not limited to,”) unless otherwise claimed. No language in the specification should be construed as indicating that any non-claimed element is essential to the practice of the invention.

It is to be understood that the specific devices and/or processes illustrated in the attached drawings, and described in the foregoing specification are exemplary embodiments of the inventive concepts defined in the appended claims. Hence, specific dimensions and other physical characteristics relating to the embodiments disclosed herein are not to be considered as limiting, unless the claims expressly state otherwise.

Preferred embodiments of this invention are described herein. Variations of those preferred embodiments will be apparent to those having ordinary skill in the art upon reading the foregoing description and viewing the appended drawings. The inventors expect that skilled artisans will employ such variations as appropriate, and the inventors intend for the invention to be practiced other than as specifically described herein. Accordingly, the invention includes all modifications and equivalents of the subject matter recited in the claims appended hereto as permitted by applicable law. Moreover, any combination of the above-described elements in all possible variations hereof is encompassed by the invention unless otherwise indicated herein or otherwise clearly contradicted by context.

While the disclosure above sets forth the principles of the present invention, with the examples given for illustration only, one should realize that the use of the present invention includes all usual variations, adaptations and/or modifications within the scope of the claims attached as well as equivalents thereof. Those skilled in the art will appreciate from the foregoing that various adaptations and modifications of the just described embodiments can be configured without departing from the scope and spirit of the invention. Therefore, it is to be understood that, within the scope of the appended claims, the invention may be practiced other than as specifically described herein.

1. A dispenser and measuring cap closure for measuring and dispensing a substance from a storage container, comprising:
a) a proximal end piece comprising:
i) an internal surface,
ii) an external surface,
iii) an external edge,
iv) a closeable dispensing spout extending axially through said proximal end piece, the interior of said dispensing spout defining a volume, said spout comprising:
1) an inlet disposed on and flush against said internal surface, and
2) an outlet extending from said external surface, and
v) a dispensing spout lid attached to the external surface of said proximal end piece, said lid being adapted to releasably and sealably close said spout;
b) an interface adapted to sealably engage the opening of a storage container, said interface comprising:
i) an outside edge,
ii) an upper side, and
iii) a lower side facing said storage container, the lower side comprising a shallow funnel having a wide mouth that slopes away from said storage container toward said proximal end piece and which defines a short stem and an aperture at its narrower terminal end;
c) a divider positioned between and adjacent to said proximal end piece and said interface, said divider being adapted to rotate around a central axis relative to said proximal end piece and said interface, said divider comprising:
i) an upper surface,
ii) a lower internal surface,
iii) an exterior rim that extends radially beyond and overlaps at least a portion of the respective adjacent edges of the proximal end piece and the interface, said exterior rim being adapted to be manipulated by a user, and
iv) a hollow measuring chamber duct extending axially through said divider from said upper surface to said lower internal surface, the interior of said measuring chamber duct defining a volume; and
d) an axle extending through and connecting said proximal end piece, said divider and said interface along a central axis;
wherein the inlet of said closeable dispensing spout and said funnel stem are disposed on opposite sides of said central axis from each other, are not rotatable relative to each other, and cannot be vertically aligned with each other,
wherein said measuring chamber duct is disposed in said divider at a location radial to said central axis and is rotatable around said central axis between a first position in operational alignment with said funnel stem and a second position in operational alignment with the inlet of said dispensing spout, said first and second positions being adapted to preclude the operational alignment of said measuring chamber duct with said stem and said dispensing spout at the same time, and
wherein the volume of said dispensing spout is substantially equal to or greater than the volume of said measuring chamber duct.

2. The cap of claim 1, wherein the internal surface of said proximal end piece further comprises a stop member adapted to facilitate precise operational alignment of said measuring chamber duct with said dispensing spout and said funnel stem by limiting the rotation of said duct to an angle defined by a first position in operational alignment with said funnel stem and a second position in operational alignment with the inlet of said dispensing spout.

3. The cap of claim 1, wherein said cap is contaminant and spill resistant.

4. The cap of claim 1, wherein said axle further comprises a locking mechanism that selectably inhibits the rotation of said divider.

5-8. (canceled)

9. The cap of claim 1, wherein said divider comprises a plurality of measuring chamber ducts, each defining a different volume.

10. The cap of claim 1, wherein said interface is molded together with a storage container as a single piece, and said storage container comprises a separate opening for placing a substance in the storage container.

11. The cap of claim 1, wherein said interface further comprises a releasable seal to engage the opening of a storage container.

12. The cap of claim 11, wherein said interface comprises screw threads, latches, insets, snaps, clips, tape, adhesive, a nesting diameter or interlocking complementary geometry.

13. The cap of claim 1, wherein the volume of said measuring chamber duct is a single dose amount for said substance to be measured and dispensed.

14. The cap of claim 1, wherein the substance measured and dispensed comprises a medicine, a medicament, a dietary supplement, a vitamin, a cereal grain, a protein powder, coffee, tea, sweetener, cough syrup, honey, baby formula, baby food, an analgesic gel, a food additive or a thickener.

15. The cap of claim 1, wherein said inlet, said funnel stem and said measuring chamber duct have an opening with a diameter of about the same size and shape.

16. (canceled)

17. The cap of claim 1, wherein said measuring chamber duct is closed at one end by the internal surface of said proximal end piece when said measuring chamber duct is not in operational alignment with said closeable dispensing spout.

18. The cap of claim 1, wherein said measuring chamber duct is closed at one end by the upper side of said interface end when said measuring chamber duct is not in operational alignment with said funnel stem.

19. The cap of claim 1, wherein said funnel stem is closed by the lower internal surface of said divider when said measuring chamber duct is not in operational alignment with said funnel stem.

20. The cap of claim 1, wherein the inlet of said closeable dispensing spout is closed by the upper surface of the divider and retains a measured amount of the substance to be dispensed inside said closed spout until said spout lid is opened by a user.

21. A method for measuring and dispensing a substance using a cap, comprising:
sealably engaging a cap with the opening of a storage container, said cap comprising:
a proximal end piece comprising an internal surface, an external surface, a closeable dispensing spout extending axially through said proximal end piece, said spout comprising an inlet disposed on and flush against said internal surface and an outlet extending from said external surface, and a dispensing spout lid attached to the external surface of said proximal end piece, said lid being adapted to releasably and sealably close said spout,
an interface adapted to sealably engage the opening of a storage container, said interface comprising an outside, an upper side, and a lower side facing said storage container, the lower side comprising a shallow funnel having a wide mouth that slopes away from said storage container toward said proximal end piece and which defines a short stem and an aperture at its narrower terminal end,
a divider positioned between said proximal end piece and said interface, said divider being adapted to rotate around a central axis relative to said proximal end piece and said interface, said divider comprising an upper surface, a lower internal surface, an exterior rim adapted to be manipulated by a user, and a hollow measuring chamber duct extending axially through said divider from said upper surface to said lower internal surface, the interior of said measuring chamber duct defining a volume, and
an axle extending through and connecting said proximal end piece, said divider and said interface along a central axis,
wherein the inlet of said closeable dispensing spout and said funnel stem are disposed on opposite sides of said central axis from each other, are not rotatable relative to each other, and cannot be vertically aligned with each other, and
wherein said measuring chamber duct is disposed in said divider at a location radial to said central axis and is rotatable around said central axis between a first position in operational alignment with said funnel stem and a second position in operational alignment with the inlet of said dispensing spout, said first and second positions being adapted to preclude the operational alignment of said measuring chamber duct with said stem and said dispensing spout at the same time;
arranging said divider around said central axis to put said measuring chamber duct into operational alignment with said funnel stem at said first position;
inverting said cap and storage container to fill said duct with said substance contained inside said container;
rotating said divider around said central axis to measure a desired amount of said substance and bring said measuring chamber duct into operational alignment with said closeable dispensing spout at said second position;
opening said closeable dispensing spout lid; and
dispensing a measured amount of said substance through or from said spout.

22. The method of claim 21 wherein said cap is spill and contamination resistant.

23. The method of claim 21, wherein said inverting step is performed before said arranging step.

24. The method of claim 21, further comprising:
transferring the measured amount of substance from said measuring chamber duct into said closeable dispensing spout, said spout lid being in a closed position;
removing said measuring chamber duct from operational alignment; and
retaining said measured amount of substance inside said closed spout until said spout lid is opened and the substance dispensed by a user.

25. The method of claim 21, further comprising dispensing the measured amount of substance in one step by rotating said divider around said central axis to bring said measuring chamber duct into operational alignment with said closeable dispensing spout, wherein said closeable dispensing cap is open.

26. The method of claim 21, wherein the internal surface of the proximal end piece of said cap further comprises a stop member.

27. The method of claim 26, further comprising precisely aligning said measuring chamber duct with said funnel stem and said dispensing spout using said stop member.

28. The method of claim 21, wherein said divider comprises a plurality of measuring chamber ducts, each defining a different volume.

29. The method of claim 28, wherein said cap further comprises indicia indicating the volume of each of said measuring chamber duct of the plurality and operational alignment.

30. The method of claim 29, wherein said arranging step further comprises selecting one of the plurality of measuring chamber ducts having a desired volume and rotating the selected duct into operational alignment with said funnel stem at said first position.
